(19) United States
(12) Patent Application Publication
(10) Pub. No.: US 2015/0234827 A1
(43) Pub. Date: Aug. 20, 2015

(54) METHOD, APPARATUS, AND DEVICE FOR RANKING SEARCH RESULTS

(71) Applicant: Baidu Online Network Technology (Beijing) Co., LTD, Beijing (CN)

(72) Inventor: Guanchen Lin, Beijing (CN)

(21) Appl. No.: 14/412,372

(22) PCT Filed: Nov. 28, 2012
(86) PCT No.: PCT/CN2012/085464

§ 371 Date: Mar. 30, 2015

(30) Foreign Application Priority Data
Aug. 22, 2012 (CN) 201210301231.7

(51) Int. Cl. G06F 17/30

(52) U.S. Cl. CPC G06F 17/3053; G06F 17/30997; G06F 17/30867

(57) ABSTRACT

A ranking apparatus for ranking search results includes a search-result-obtaining module configured to perform a match query, based on a query sequence from a mobile terminal, to obtain search results matching the query sequence and relevancy information indicative of relevance between the query sequence and the search results, and a search-result-determining module that determines a search result. The result directs to corresponding first and second page types. The second type is suitable for mobile terminal display. An adjustment-information-determining module determines rank adjustment information to which the search result corresponds based on a characteristic degree of the second page type directed to by the search result, and a first ranking-module configured to rank search results based on relevancy information between the query sequence and the search results and the rank adjustment information to which the search result corresponds respectively to obtain a ranked search results.

### RELATED APPLICATIONS

This application is the national stage entry of international application PCT/CN2012/085464, filed on Nov. 28, 2014, which claims the benefit of the Aug. 22, 2012 priority date of Chinese application 201210301231.7, the contents of which are herein incorporated by reference.

### FIELD OF THE INVENTION

The present invention relates to ranking search results.

### BACKGROUND OF THE INVENTION

Currently, mobile Internet has played a more and more important role in people's life. People may perform information searches in the Internet through a mobile terminal anytime and anywhere.

In the prior art, the mobile terminal generally presents the user with a plurality of search result items obtained by a search engine based on a query sequence. These are provided to the mobile terminal after ranking according to a query sequence specified by a user.

However, not all pages are designed to look good on a mobile device. In general, a user cannot know which ones of the many search result pages can be displayed on the mobile terminal with a better presentation effect, or whether the user can get a better browsing experience through browsing such search result pages.

As a result, the user is forced to engage in the laborious exercise of clicking the page link in each search result to enter into the search result page, and browsing each search result page to judge whether the display is suitable. This troublesome operation degrades the user's browsing experience. Meanwhile, access to a considerable number of search result pages not suitable for being presented in the screen of the mobile terminal not only degrades the information obtaining efficiency of the user, but also causes much unnecessary communication traffic.

### SUMMARY OF THE INVENTION

An objective of the present invention is to provide a method, apparatus and device for ranking search results.

According to one aspect of the present invention, there is provided a method for ranking search results, the method comprising steps of performing match query based on a query sequence from a mobile terminal to obtain a plurality of search results matching the query sequence and relevancy information between the query sequence and the plurality of search results, determining at least one search result in the plurality of search results, wherein each search result in the at least one search result is directed to a first type of page and a second type of page having a page correspondence relationship, wherein the second type of page is a page that is suitable for being displayed on the mobile terminal; determining rank adjustment information to which the at least one search result corresponds respectively based on a characteristic degree of the second type of page directed to by each search result in the at least one search result; and performing a ranking process on the plurality of search results based on the relevancy information between the query sequence and the plurality of search results and the rank adjustment information to which the at least one search result corresponds respectively, so as to obtain a plurality of ranked search results.

According to another aspect of the present invention, there is provided an apparatus for ranking search results. Such an apparatus comprises a search-result-obtaining module configured to perform a match query based on a query sequence from a mobile terminal, to obtain a plurality of search results matching the query sequence and relevancy information between the query sequence and the plurality of search results. The apparatus also includes a search-result-determining module configured to determine at least one search result in the plurality of search results, wherein each search result in the at least one search results directs to a first type of page and a second type of page having a page correspondence relationship, wherein the second type of page is suitable for being displayed on the mobile terminal; an adjustment-information-determining module configured to determine rank adjustment information to which the at least one search result corresponds respectively based on a characteristic degree of the second type of page directed to by each search result in the at least one search result; and a first ranking module configured to perform a ranking processing to the plurality of search results based on the relevancy information between the query sequence and the plurality of search results and the rank adjustment information to which the at least one search result corresponds respectively, so as to obtain a plurality of ranked search results.

Compared with the prior art, the present invention has several advantages. By performing ranking processing to a plurality of search results based on the relevancy information between each search result and the query sequence and the rank adjustment information respectively corresponding to the at least one search result having a page correspondence relationship, the ranking manner for the plurality of search results is not only related to the match degree with the query sequence inputted by the user, but also associated with whether the search result page is suitable for being presented on the mobile terminal. This results in search results corresponding to the second type of pages suitable for being presented on the mobile terminal and having a higher page quality and the search results which correspond to the first type of pages and the second type of pages which are suitable for being presented on the mobile terminal and have relatively higher page similarity information, can be ranked at higher positions of the search result pages, and the user may click onto several search results ranked top in a visual area most convenient for the user to obtain information, to obtain the search result webpages suitable for the user to browse at the mobile terminal, thereby the user's browsing experience has been improved.

### BRIEF DESCRIPTION OF THE ACCOMPANYING DRAWINGS

Other features, objectives and advantages of the present invention will become more apparent through the following detailed description of non-limiting embodiments with reference to the following drawings, in which:

FIG. 1 shows a structural schematic diagram of a ranking apparatus for ranking search results according to one aspect of the present invention;

FIG. 2 shows a structural schematic diagram of a ranking apparatus for determining page similarity information between a first type of page and a second type of page, which are directed to by the each search result according to one preferred embodiment of the present invention;

FIG. 3 shows a flow diagram of a method for ranking search results according to another aspect of the present invention; and

FIG. 4 shows a flow diagram of a method for determining page similarity information between a first type of page and a second type of page, which are directed to by the each search result according to one preferred embodiment of the present invention.

In the accompanying drawings, same or similar reference numerals represent same or similar components.

### DETAILED DESCRIPTION

Hereinafter, the present invention will be described further in detail with reference to the accompanying drawings.

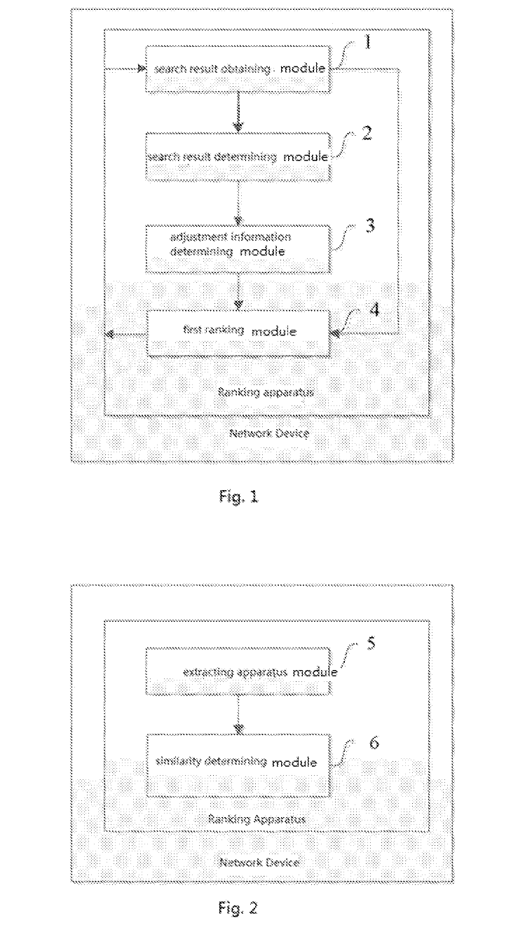

FIG. 1 shows a structural schematic diagram of a ranking apparatus for ranking search results according to one aspect of the present invention. The ranking apparatus according to the present embodiment is included in a network device. The ranking apparatus comprises a search-result-obtaining module 1, a search-result-determining module 2, an adjustment-information-determining module 3, and a first ranking module 4.

The network device includes, but is not limited to, a single network server, a server cluster composed of a plurality of network servers, or a cloud composed of mass computers or network servers based on the cloud computing, wherein cloud computing is a kind of distributed computation based on a super virtual computer composed of a set of loosely coupled computers.

First, the search-result-obtaining module 1 performs a match query based on a query sequence from a mobile terminal, to obtain a plurality of search results matching the query sequence and relevancy information between the query sequence and the plurality of search results.

The mobile terminal includes, but is not limited to, any kind of mobile electronic product that is applicable to the present invention and that may interact with a user through a keyboard, a touch screen, and the like, including, but is not limited to, a mobile phone, a PDA, a P Palmtop Computer (PPC), a game machine, etc. Here, both the network device and the mobile terminal include an electronic device that can automatically perform numerical value computation and information processing based on a pre-set or pre-stored instruction, whose hardware may include, but is not limited to, a microprocessor, an application-specific integrated circuit (ASIC), a programmable gate array (FPGA), a digital processor (DSP), an embedded device, and the like.

The above mobile terminals and network devices are only examples, and other mobile terminals and network devices, whether existing or yet to be developed, if applicable to the present invention, should also be included within the protection scope of the present invention.

Communication between the mobile terminal and the network device may be implemented through any communication method, including, but is not limited to, mobile communication based on 3GPP, LTE, or WIMAX, computer network communication based on TCP/IP, or UDP protocol, and a near-range wireless transmission manner based on Bluetooth, or an infrared transmission standard. The network connected between the mobile terminal and the network device includes, but is not limited to, the Internet, a wide area network, a metropolitan area network, a local area network, a VPN network, an ad hoc network, and the like.

Specifically, the search-result-obtaining module 1 performs match query based on the query sequence input by a user from a mobile terminal, and performs search based on the received query sequence. Generally, the search process is specified as follows: the query sequence contains one or more key words, and preferably further contains correlation words between the key words; the search-result-obtaining module 1 will extract these key words, and preferably, also extract the correlation words, and perform match query in a network index library based on the keywords or based on the key words and correlation words to obtain a plurality of search results, wherein the relevancy information between each search result and the query sequence may be determined based on various search algorithms, e.g., determining the relevancy information based on a traditional click rate algorithm, determining the relevancy information based on the “PageRank” search algorithm of Google (see U.S. Pat. No. 6,285,699, “Method for Node Ranking in a Linked Database”), and determining the relevancy information based on the “Super-link” search algorithm of Baidu. The search-result-obtaining module 1 obtains the relevancy information between each search result and the query sequence based on the above search algorithms, wherein the relevancy information refers to a match degree score between a search result and a query sequence as determined based on a basic search algorithm such as “PageRank,” “Super-link,” and the like.

It should be noted that the above example is only for better illustrating the technical solution of the present invention, and is not intended to limit the present invention. Any implementation method for performing a match query based on a query sequence from a mobile terminal to obtain a plurality of search results matching the query sequence and relevancy information between the query sequence and the plurality of search results is included within the scope of the present invention.

The search-result-determining module 2 determines at least one search result in the plurality of search results, wherein each search result in the at least one search results directs to a first type of page and a second type of page that have a page correspondence relationship, wherein the second type of page is a page suitable for being displayed on the mobile terminal.

The first type of page is a page suitable for being displayed on a computer device, e.g., web pages, i.e., files based on markup languages such as HTML, XML, XHTML on a world wide web; when the user performs information query through the world wide web, the pages appear as information pages, which may include information such as images, texts, voice, and video, etc.

The second type of page refers is a page suitable for being displayed on a mobile terminal. These include, for example, WAP pages, i.e., files based on the wireless markup language (WML). A mobile terminal may access a WAP website based on the wireless application protocol (WAP). The files are suitable for being displayed on a mobile terminal with a smaller screen.

Herein, the manner of the determining, by the search-result-determining module 2, at least one search result in a plurality of search results, includes, but is not limited to, performing a match query in a page correspondence list based on the link information of each search result to determine at least one search result in a plurality of search results, wherein each search result in the at least one search result is directed to a first type of page and a second type of page having a page correspondence relationship with each other.

In one example, the search-result-determining module 2 performs a match query with link information of each search result in a predetermined page correspondence list to determine whether each search result directs to the first type of page and the second type of page having a page correspondence relationship with each other; wherein the page correspondence list includes link information of a plurality of search results directing to the first type of page and the second type of page having a page correspondence relationship. Preferably, it may be determined whether the plurality of search results are directed to the first type of page and the second type of page having a page correspondence relationship by pre-mining mass pages in the Internet through a network device.

Preferably, the search-result-determining module 2 comprises a tag-extracting module (not shown). The tag-extracting module determines, through extracting a predetermined tag in a markup language file of the first type of pages to which the plurality of search results correspond respectively, at least one search result having a page correspondence relationship in the plurality of search results.

Specifically, the tag-extracting module extracts a predetermined tag in a markup language file of the first type of pages to which a plurality of search results correspond respectively. Next, by reading predetermined attribute information in the predetermined tag, at least one search result having a page correspondence relationship in the plurality of search results is determined.

A markup language file includes, but is not limited to: HTML (Hypertext Markup Language) files; XML (Extensive Markup Language) files; XHTML (Extensible Hypertext Markup Language) files; XAML (Extensible Application Markup Language) files, etc.

In one example, a first type of page to which a search result corresponds, e.g., a HTML file of the WEB page is specified below:

<head>
<meta name = “mobile-agent” content = “format = html5; url
= http://3g.abc.com.cn/”>
...
</head>;

The tag-extracting module extracts a predetermined <meta> tag of the HTML file, and then reads the attribute value “format=html5; url=http://3g.abc.com.cn/” of the content in the <meta> tag, to determine that the corresponding link information of the WAP page corresponding to the search result is “http://3g.abc.com.cn/” and that the markup language file of the WAP page is HTML5, i.e., determining that the search result is a search result having a page correspondence relationship.

It should be noted that the above example is only for better illustrating the technical solution of the present invention, and is not intended to limit the present invention. Any method of determining, through extracting a predetermined tag in a markup language file of the first type of pages to which the plurality of search results correspond respectively, at least one search result having a page correspondence relationship in the plurality of search results, can be used in connection with the practice of the invention.

The foregoing example is only for better illustrating the technical solution of the present invention, and is not intended to limit the present invention. The invention can be practiced using any method of determining at least one search result in a plurality of search results, wherein each search result in the at least one search result is directed to a first type of page and a second type of page having a page correspondence relationship, wherein the second type of page is a page suitable for being displayed on a mobile terminal.

Next, the adjustment-information-determining module 3 determines rank adjustment information to which the at least one search result corresponds respectively based on a characteristic degree of the second type of page directed to by each search result in the at least one search result.

The characteristic degree of the second type of page includes at least one of page quality of the second type of page to which each search result directs, and page-similarity information between the second type of page and the first type of page that are directed to by each search result.

The characteristic degree of the second type of page as noted above is only exemplary. Other characteristics, whether existing or yet to be developed, can also be used without departing from the scope of the invention.

Specifically, the manner of determining, by the adjustment-information-determining module 3, rank adjustment information of each search result, includes, but is not limited to first, retrieving pre-stored page quality of the second type of page to which each search result directs and page similarity information between the second type of page and the first type of page to which the search result directs from a preset characteristic degree database; next, based on the page quality and the page-similarity information, determining rank-adjustment information of the search result through methods such as simple summing or weighted calculation; wherein the adjustment information library includes, but is not limited to, a relation database, a key-value storage system, or file system.

In one example, in which at least one search result is A1, A2, the adjustment-information-determining module 3 performs match query in a preset characteristic degree database based on the link information of A1 and A2 to retrieve the scores for pre-stored page qualities of the WAP pages to which A1 and A2 direct respectively, which are QA1 and QA2, and the scores for page-similarity information of the WAP page and WEB page to which A1 and A2 direct respectively, which are SA1 and SA2.

The procedure includes extracting main page content blocks of the first type of page and the second type of page to which each search result in the at least one search result directs. It continues with calculating text similarity for the main page content blocks of the first type of page and the second type of page for each search result to determine page similarity information of the first type of page and the second type of page to which the each search result directs. This method will be described in detail in the embodiment shown in FIG. 2.

The page quality of the second type of page to which the at least one search result directs respectively is determined based on at least one of page richness of the second type of page, and relevancy information between the header information of the second type of page and the content information of the second type of information.

The particular method described for determining the page quality of the second type of page to which the at least one search result directs respectively is only exemplary. Other methods for doing the same thing, whether existing or yet to be developed, can be used without leaving the scope of the invention.

Specifically, the manner of determining a page richness of the second type of page includes, but is not limited to:

extracting a page content block in a markup language file of the second type of page to which the search result directs, e.g., a body content block, calculating a text information length in the body content block, determining a page richness of the second type of page according to the number of characters of the text information in the body content block. This can be done based on a first predetermined richness rule. An example would be one that states that the richness of the second type of page increases as the number of characters of the text information in the body content block in the second type of page increases.

The page content block in the markup language file includes a content area identified by one or more tags in the markup language file. The content area corresponds to specific content displayed on the page, e.g., corresponding to headers, pictures, body contents, etc.

Page content blocks are extracted in the markup language file of the second type of page. Page richness of the second type of page is then determined according to the number of types of the page content blocks, and based on a second predetermined richness rule, for example, the more the number of types of the page content blocks included in the second type of page is, e.g., body content block, header content block, picture content block, message content block, etc., the higher is its page richness.

In one example, the page content block identification information is stored in a tag attribute of a markup language file XMTML file of a WAP page to which the search result A1 directs, e.g., in the tag attribute of a paragraph tag <p>, the ranking apparatus resolves the XHTML file to determine the paragraph tag attribute <p tc_type=“TEXT”> for marking up the body content block in the XHTML file; then, the XHTML file portion between the paragraph tag <p tv_type=“TEXT”> and </p> is extracted to obtain the body content block of the page, and then the number of characters of the text information in the body content block is calculated to obtain that the number of characters of the text information is 100 characters; the score of the page richness of the WAP page is incremented by 1 when the number of characters of text information in the body content block is greater than 100 characters based on a first predetermined richness rule; meanwhile, the ranking apparatus determines, through resolving the XHTML file, that the WAP page to which A1 directs to comprises four kinds of page content blocks, which are body content block, header content block, catalog content block, and picture content block, and based on a second predetermined richness rule, when the second type of page includes more than four kinds of page content blocks, the score of the page richness of the second page is added by 1, i.e., the score rA1 of the page richness of the WAP page to which A1 directs is 2.

Specifically, the manner of determining relevancy information between the header information of a second type of page and the content information of a second type of page includes, but is not limited to: determining relevancy information of the two through TF-IDF algorithm based on the header information of the second type of page and the content information of the second type of page; wherein, the TD-IDF is a statistical method, for evaluating the importance degree of one word with respect to one file in a file set or corpus.

In one example, the ranking apparatus performs word segmentation processing to the header information “flower express” of the WAP page to which the search result A1 directs to obtain two phase segments: P1 “flower” and P2 “express”; next, query is performed in a preset corpus to determine that the appearance frequencies TPs of the two phase segments in the preset corpus are 100 times and 200 times, respectively, taking the reciprocals of the appearance frequencies as the inverse text frequency IDF of each phase segment which are 0.01 and 0.005, respectively; besides, it is determined that the appearance frequencies TFs of the two phase segments in the text information of the body content block of the WAP page are 10 times and 20 times, respectively; afterwards, calculation is performed through equation 1):

Pn=TFn*IDFn 1)

wherein, Pn denotes a score of relevancy information between each phase segment and content information of the WAP page, TFn denotes respective appearance frequency of each phase segment in the text information of the body content block of the WAP page, IDFn denotes a reciprocal of appearance frequency of each word segment in a preset corpus. To determine that the score of relevancy information between each word segment and the content information of the WAP page is:

P1: 0.01*10=0.1;

P2: 0.005*20=0.1;

performing summing calculation with respect to the scores of relevancy information between the two phase segments and the content information of the WAP page, to obtain that the score CA1 (=p1+p2) of the relevancy information between the header information of the WAP page to which the search result A1 directs and the content information of the WAP page is 0.2.

Preferably, the score rAn of the page richness of the second type of page to which each search result directs and the score CAn of the relevancy information between the header information of the second type of page and the content information of the second type of page are subject to simple summing or weighted calculation, etc., for example, through the following equation 2):

QAn=rAn+CAn

wherein QAn denotes a score of a page quality of the second type of page, rAn denotes a score of a page richness of the second type of page, CAn denotes a score of a page richness of the second type of page; to obtain a score QAn of the page quality of the second type of page to which each search result in at least one search result directs.

It should be noted that the above example is only for better illustrating the technical solution of the present invention, and is not intended to limit the present invention. Any manner of determining rank adjustment information to which at least one search result corresponds respectively, based on the determined characteristic degree of the second type of page to which each search result in the determined at least one search result directs, can be used without departing from the scope of the present invention.

Afterwards, the first ranking module 4 performs a ranking process on the plurality of search results based on the relevancy information between the query sequence and the plurality of search results and the rank adjustment information to which the at least one search result corresponds respectively, so as to obtain a plurality of ranked search results.

The manner in which the first ranking module 4 performs a ranking process on a plurality of search results to obtain a plurality of ranked search results includes, but is not limited to performing a summing calculation based on the scores of relevancy information between each search result and a query sequence, the score of page quality of the second type of page to which at least one search result having a page correspondence relationship directs respectively, and the score of page similarity information between the second type of page and the first type of page to which the at least one search result having a page correspondence relationship directs respectively, and performing a ranking operation based on the summing results.

In one example, a plurality of search results are A1, A2, A3, and A4; the scores of the relevancy information between the four search results obtained by the search-result-obtaining module 1 and the query sequence are RA1: 10, RA2: 5, RA3: 4, and RA4: 3; in the four search results, A1 and A4 are search results having a page correspondence relationship, and the scores of the page qualities of the second type of pages to which A1 and A4 directs respectively and obtained by the adjustment-information-determining module 3 are QA1: 1 and QA4: 4; the scores of the page similarity information between the second type of pages and the first type of pages to which A1 and A4 directs respectively and obtained by the adjustment-information-determining module 3 are SA1: 0.5 and SA 4: 0.9; the first ranking module 4 performs summing calculation to the relevancy information, the score of the page quality of the second type of page, and the score of the page similarity information between the second type of page and the first type of page, of A1 and A4, namely, through equation 3):

sn=RAn+QAn+SAn 3)

wherein, sn denotes the summing result, RAn denotes the score of relevancy information of each search result and the query sequence, QAn denotes the score of the page quality of the second type of page to which each search result directs, and SAn denotes the score of the page similarity information between the second type of page and the first type of page to which each search result directs.

The obtained summing result is:

s1:=10+1+0.5=11.5;

s4:=3+4+0.9=7.9;

then the first ranking module 4 ranks the four search results based on the relevancy information of A2 and A3, as well as the summing result, obtaining the ranked four search results being A1, A4, A2, and A3.

It should be noted that the above example is only for better illustrating the technical solution of the present invention, rather than limiting the present invention. Those skilled in the art should understand, any implementation manner of performing a ranking processing to the plurality of search results based on the relevancy information between the query sequence and the plurality of search results and the rank adjustment information respectively corresponding to the at least one search result, so as to obtain a plurality of ranked search results, should fall into the scope of the present invention.

By performing a ranking processing to a plurality of search results based on the relevancy information between each search result and the query sequence and the rank adjustment information respectively corresponding to the at least one search result having a page correspondence relationship, a ranking manner for the plurality of search results is not only related to the match degree with the query sequence inputted by the user, but also associated with whether the search result page is suitable for being presented on the mobile terminal, such that the search results corresponding to the second type of page suitable for being presented on the mobile terminal and having a higher page quality and the search results which correspond to the first type of page and the second type of page, are suitable for being presented on the mobile terminal, and have relatively higher page similarity information, can be ranked at higher positions of the search result pages, and the user may click onto several search results ranked top in a visual area most convenient for him/her to obtain information, to obtain the search result webpages suitable for him/her to browse at the mobile terminal, thereby improving the user's browsing experience.

Preferably, the first ranking module 4 further comprises a weighting module (not shown) and a second ranking module (not shown). The weighting module performs weighted calculation based on the relevancy information between the query sequence and the plurality of search results and the rank adjustment information respectively corresponding to the at least one search result, and in conjunction with the predetermined weights of the relevancy information and the rank adjustment information, to determine a weighted ranking result for each search result; the second ranking module performs a ranking processing to the plurality of search results based on the weighted ranking result of the each search result to obtain a plurality of ranked search results.

In one example, a plurality of search results are A1, A2, A3, and A4; the scores of the relevancy information between the four search results obtained by the search-result-obtaining module 1 and the query sequence are RA1: 10, RA2: 5, RA3: 4, and RA4: 3; in the four search results, A1 and A4 are search results having a page correspondence relationship, and the scores of the page qualities of the second type of page to which A1 and A4 directs respectively and obtained by the adjustment-information-determining module 3 are QA1: 1 and QA4: 4; the scores of the page similarity information between the second type of page and the first type of page to which A1 and A4 direct respectively and obtained by the adjustment-information-determining module 3 are SA1: 0.5 and SA4: 0.9; additionally, the predetermined weight of the relevancy information is W1: 1; the predetermined weight of the page quality of the second type of page to which the search result directs is W2: 0.4; the predetermined weight of the page similarity information between the second type of page and the first type of page to which the search result directs is W3: 0.3; then the weight determining module performs weighted calculation to the relevancy information the score of the page quality of the second type of page, and the score of the page similarity information between the second type of page and the first type of page, of A1 and A4, namely, through equation 4):

Sn=RAn*W1+QAn*W2+SAn*W3 4)

to obtain the weighted results as:

S1:=10*1+1*0.4+0.5*0.3=10.55;

S4:=3*1+4*0.4+0.9*0.3=4.87;

then the second ranking module ranks the four search results based on the relevancy information of A2 and A3, as well as the weighted results, to obtain the four ranked search results to be A1, A2, A4 and A3.

It should be noted that the above example is only for better illustrating the technical solution of the present invention, rather than limiting the present invention. Those skilled in the art should understand, any implementation manner of performing weighted calculation based on the relevancy information between the query sequence and the plurality of search results and the rank adjustment information respectively corresponding to the at least one search result and in conjunction with predetermined weights of the relevancy information and the rank adjustment information, to determine a weighted ranking result for each search result, and then performing a ranking processing to the plurality of search results based on the weighted ranking result of the each search result to obtain a plurality of ranked search results, should fall into the scope of the present invention.

Since different ranking dimensions for ranking at least one search result having a page correspondence relationship have different impacts on the suitability of presenting the search results on the mobile terminal; therefore, by assigning different weights based on the importance of respective ranking dimensions, the search result page corresponding to the finally obtained plurality of ranked search results not only has a higher match degree with the query sequence, but also is suitable to be presented on a mobile terminal, such that the user can obtain a plurality of ranked search results simultaneously satisfying his/her query needs and the browsing experience.

As one of the preferred solutions of the present embodiment, FIG. 2 shows a structural schematic diagram of a ranking apparatus for determining page similarity information between a first type of page and a second type of page, which are directed to by the each search result according to one preferred embodiment of the present invention, wherein the ranking apparatus comprises a search-result-obtaining module 1, a search-result-determining module 2, an adjustment-information-determining module 3, a first ranking module 4, an extracting module 5, and a similarity determining module 6.

Herein, the search-result-obtaining module 1, the search-result-determining module 2, the adjustment-information-determining module 3, and the first ranking module 4 have been described in detail in the embodiment shown in FIG. 1, which will not be detailed here.

The extracting module 5 extracts main page content blocks of the first type of page and the second type of page to which each search result in the at least one search result directs.

Herein, the manner of storing the page content block identification information in the first type of page and the second type of page to which each search result in the at least one search result directs includes, but is not limited to, at least any one of the following manners:

1) stored in the annotation of a markup language file;

For example, with a JSON format, the page content block identification information is stored in the annotation of an XHTML file, e.g., <!-- tc block_begin: {type: “TITLE”} --<>!-- tc block_end -->; by resolving the XHTML file, the extracting module 5 determines an annotation for marking up the header content block from within the XHTML file, to extract the HTML file portion between the annotations <!-- tc block_begin: {type: “TITLE”} --> and <!-- tc block_end -->, thereby extracting the header content block of the page; wherein the JSON format is a light-weight data exchange format, which generally adopts a “name/ value” pair approach to represent data, and the name and the value is separated with “:”.

2) stored in a customized tag of the markup language file;

For example, the page content block identification information is stored in a customized tag <tc></tc> of the XHTML file; by resolving the XHTML file, the extracting module 5 determines, in the XHTML file, the customized tag <tc type=“photo”> for marking up a picture content block, to extract the HTML file portion between <tc type=“photo”> and </tc>, thereby obtaining the picture content block of the page.

3) stored in a tag attribute of the markup language file;

For example, the page content block identification information is stored in the tag attribute of the XHTML file, e.g., in the tag attribute of the paragraph tag <p>; by resolving the XHTML file, the extracting module 5 determines, in the XHTML file, the paragraph tag attribute <p tc_type=“TEXT”> for annotating a body content block, and then extracts the XHTML file portion between the paragraph tag <p tc_type=“TEXT”> and </p>, to obtain the body content block of the page.

In one example, the search result having a page correspondence relationship is A5; the extracting module 5 extracts within a markup language file of the first type of page and the second type of page to which each search result directs, to extract and obtain the header content block and the body content block included in the first type of page and the second type of page of A5, respectively, as the main page content blocks of the two pages.

Afterwards, a similarity determining module 6 performs text similarity calculation with respect to the main page content blocks of the first type of page and the second type of page of each search result, to determine the page similarity information between the first type of page and the second type of page to which each search result directs.

Herein, the manner of determining page similarity between the first type of page and the second type of page to which each search result directs includes, but is not limited to:

1) calculating with the TF-IDF algorithm to determine; e.g., extracting a plurality of key words in the main page content block of the first type of page, and then determining the appearance frequencies of the plurality of key words in the main content block of the second type of page, respectively, and determine, with the TF-IDF algorithm, the page similarity between the first type of page and the second type of page;

2) spatial vector-based cosine algorithm; wherein the processing process of the algorithm comprises pre-processing such as word segmenting the text information, and then filtering off common adverbs, auxiliary verbs which have a high frequency in the text information, determining a plurality of keywords based on the frequencies of remaining phase segments, performing weighted calculation through the TF-IDF formulation, thereby generating a spatial vector model, and finally calculating cosine, to determine the similarity between the text information in the main page content blocks in the first type of page and the second type of page.

It should be noted that the above example is only for better illustrating the technical solution of the present invention, rather than limiting the present invention. Those skilled in the art should understand, any implementation manner of extracting main page content blocks of the first type of page and the second type of page to which each search result in the at least one search result directs and then performing text similarity calculation with respect to the main page content blocks of the first type of page and the second type of page of each search result, to determine the page similarity information between the first type of page and the second type of page to which each search result directs, should fall into the scope of the present invention.

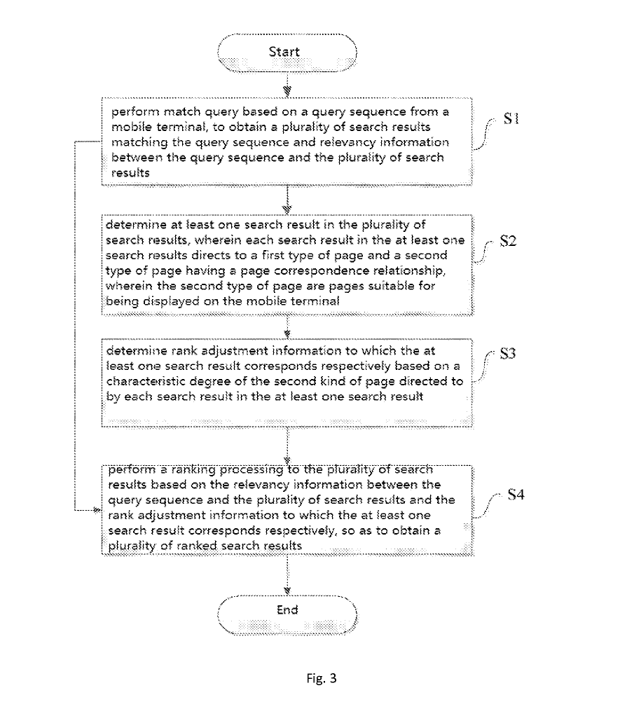

FIG. 3 shows a flow diagram of a method for ranking search results according to another aspect of the present invention. The method of the present invention is mainly implemented through a network device, wherein the method according to the present preferred embodiment comprises: step S1, step S2, step S3, and step S4.

The network device includes, but is not limited to, a single network server, a server cluster composed of a plurality of network servers, or a cloud composed of mass computers or network servers based on the cloud computing, wherein the cloud computing is a kind of distributed computation, which is a super virtual computer composed of a set of loosely coupled computers.

First, in step 1, the network device performs match query based on a query sequence from a mobile terminal, to obtain a plurality of search results matching the query sequence and relevancy information between the query sequence and the plurality of search results.

Here, the mobile terminal includes, but is not limited to, any kind of mobile electronic product that is applicable to the present invention and may interact with a user through a keyboard, a touch screen, and the like, including, but is not limited to, a mobile phone, a PDA, a P Palmtop Computer (PPC), a game machine, etc. Here, both the network device and the mobile terminal include an electronic device that can automatically perform numerical value computation and information processing based on a pre-set or pre-stored instruction, whose hardware may include, but is not limited to, a microprocessor, an application-specific integrated circuit (ASIC), a programmable gate array (FPGA), a digital processor (DSP), an embedded device, and the like.

Those skilled in the art should understand that the above mobile terminals and network devices are only examples, and other existing or future possibly emerging mobile terminals and network devices, if applicable to the present invention, should also be included within the protection scope of the present invention, and are incorporated here by reference.

Here, communication between the mobile terminal and the network device may be implemented through any communication manner, including, but is not limited to, mobile communication based on 3GPP, LTE, or WIMAX, computer network communication based on TCP/IP, or UDP protocol, and a near-range wireless transmission manner based on Bluetooth, infrared transmission standard. The network connected between the mobile terminal and the network device includes, but is not limited to, Internet, wide area network, metropolitan area network, local area network, VPN network, Ad Hoc network, and the like.

Specifically, in step S1, the network device performs match query based on the query sequence inputted by a user from a mobile terminal, and performs search based on the received query sequence. Generally, the search process is specified as below: the query sequence contains one or more key words, and preferably further contains correlation words between the key words; the network device will extract these key words, and preferably, also extracts the correlation words, and performs match query in a network index library based on the key words or based on the key words and correlation words to obtain a plurality of search results, wherein the relevancy information between each search result and the query sequence may be determined based on various search algorithms, e.g., determining the relevancy information based on a traditional click rate algorithm, determining the relevancy information based on the “PageRank” search algorithm of Google (see U.S. Pat. No. 6,285,699, “Method for Node Ranking in a Linked Database”), and determining the relevancy information based on the “Super-link” search algorithm of Baidu. The network device obtains the relevancy information between each search result and the query sequence based on one of the above search algorithms, wherein the relevancy information refers to a match degree score between a search result and a query sequence as determined based on a basic search algorithm such as “PageRank,” “Super-link,” and the like.

It should be noted that the above example is only for better illustrating the technical solution of the present invention, not intended to limit the present invention. Those skilled in the art should understand that any implementation manner of performing match query based on a query sequence from a mobile terminal, to obtain a plurality of search results matching the query sequence and relevancy information between the query sequence and the plurality of search results should be included within the scope of the present invention.

In step S2, the network device determines at least one search result in the plurality of search results, wherein each search result in the at least one search results directs to a first type of page and a second type of page, which have a page correspondence relationship, wherein the second type of page is a page suitable for being displayed on the mobile terminal.

Herein, the first type of page refers to pages suitable for being displayed on a computer device, e.g., Web pages, i.e., files based on markup languages such as HTML, XML, XHTML on a world wide web; when the user performs information query through the world wide web, the pages appear as information pages, which may include information such as images, texts, voice, and video, etc.

Herein, the second type of page refers to pages suitable for being displayed on a mobile terminal, for example, WAP pages, i.e., files based on the wireless markup language (WML); a mobile terminal may access a WAP website based on the wireless application protocol (WAP). The files are suitable for being displayed on a mobile terminal with a smaller screen.

Herein, the manner of the determining, by the network device, at least one search result in a plurality of search results, includes, but is not limited to:
performing match query in a page correspondence list based on the link information of each search result, to determine at least one search result in a plurality of search results, wherein each search result in the at least one search result is directed to a first type of page and a second type of page having a page correspondence relationship.

In one example, in step S2, the network device performs match query with link information of each search result in a predetermined page correspondence list, to determine whether each search result direct to the first type of page and the second type of page having a page correspondence relationship; wherein the page correspondence list includes link information of a plurality of search results directing to the first type of page and the second type of page having a page correspondence relationship; preferably, it may be determined whether the plurality of search results are directed to the first type of page and the second type of page having a page correspondence relationship by pre-mining mass pages in the Internet through a network device.

Preferably, the method further comprises step S7 (not shown). In step S7, the network device determines, through extracting a predetermined tag in a markup language file of the first type of pages to which the plurality of search results correspond respectively, at least one search result having a page correspondence relationship in the plurality of search results.

Specifically, in step S7, the network device extracts a predetermined tag in a markup language file of the first type of pages to which a plurality of search results correspond, respectively; next, by reading predetermined attribute information in the predetermined tag, at least one search result having a page correspondence relationship in a plurality of search results is determined.

Herein, a markup language file includes, but is not limited to: 1) HTML (Hypertext Markup Language) files; 2) XML (Extensive Markup Language) files; 3) XHTML (Extensible Hypertext Markup Language) files; 4) XAML (Extensible Application Markup Language) files, etc.

In one example, a first type of page to which a search result corresponds, e.g., a HTML file of the WEB page is specified below:

<head>
<meta name = “mobile-agent” content = “format = html5;
url = http://3g.abc.com.cn/”>
...
</head>;

In step S7, the network device extracts a predetermined <meta> tag of the HTML file, and then reads the attribute value “format=html5; url=http://3g.abc.com.cn/” of the content in the <meta> tag, to determine that the corresponding link information of the WAP page corresponding to the search result is “http://3g.abc.com.cn/” and the markup language file of the WAP page is HTML5, i.e., determining that the search result is a search result having a page correspondence relationship.

It should be noted that the above example is only for better illustrating the technical solution of the present invention, not intended to limit the present invention. Those skilled in the art should understand that any implementation manner of determining, through extracting a predetermined tag in a markup language file of the first type of page corresponding to the plurality of search results, respectively, at least one search result having a page correspondence relationship in the plurality of search results, should fall into the protection scope of the present invention.

It should be noted that the above example is only for better illustrating the technical solution of the present invention, not intended to limit the present invention. Those skilled in the art should understand that any implementation manner of determining at least one search result in a plurality of search results should fall into the scope of the present invention, wherein each search result in the at least one search result is directed to a first type of page and a second type of page having a page correspondence relationship, wherein the second type of page is a page suitable for being displayed on a mobile terminal.

Next, in step S3, the network device determines rank adjustment information to which the at least one search result corresponds respectively based on a characteristic degree of the second type of page directed to by each search result in the at least one search result.

Herein, the characteristic degree of the second type of page includes at least any one of the following:

1) page quality of the second type of page to which each search result is directed;

2) page similarity information between the second type of page and the first type of page which are directed to by each search result.

Those skilled in the art should understand that the characteristic degree of the second type of page is only exemplary, and other existing or future possibly emerging characteristic degree of the second type of page, if applicable for the present invention, should also fall into the protection scope of the present invention and is incorporated here by reference.

Specifically, in step S3, the manner of determining, by the network device, rank adjustment information of each search result, includes, but is not limited to:

1) first, retrieving pre-stored page quality of the second type of page to which each search result directs and page similarity information between the second type of page and the first type of page to which the search result directs from a preset characteristic degree database; next, based on the page quality and the page similarity information, determining rank adjustment information of the search result through manners such as simple summing or weighted calculation; wherein the adjustment information library includes, but is not limited to, a relation database, a Key-Value storage system or file system, etc.

In one example, at least one search result is A1, A2; the network device performs match query in a preset characteristic degree database based on the link information of A1 and A2 to retrieve that the scores for pre-stored page qualities of the WAP pages to which A1 and A2 direct, respectively, are QA1 and QA2, and the scores for page similarity information of the WAP page and WEB page to which A1 and A2 directs, respectively, are SA1 and SA2.

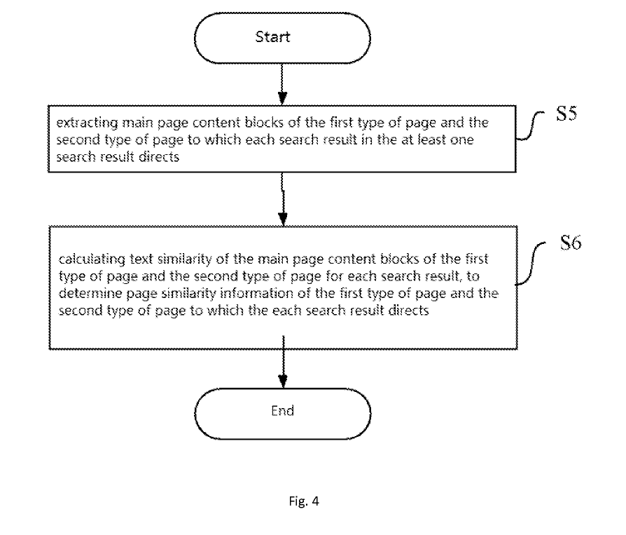

2) First, extracting main page content blocks of the first type of page and the second type of page to which each search result in the at least one search result directs; next, calculating text similarity for the main page content blocks of the first type of page and the second type of page for each search result, to determine page similarity information of the first type of page and the second type of page to which the each search result directs; this manner will be described in detail in the embodiment shown in FIG. 4.

Herein, the page quality of the second type of page to which the at least one search result directs, respectively, is determined based on at least any one of the following:

a. page richness of the second type of page;

b. relevancy information between header information of the second type of page and content information of the second type of information.

Those skilled in the art should understand that the manner of determining the page quality of the second type of page to which the at least one search result directs respectively is only exemplary, and any other existing or future possibly emerging manner of determining the page quality of the second type of page to which the at least one search result directs respectively, if applicable to the present invention, should fall into the protection scope of the present invention and is incorporated here by reference.

Specifically, the manner of determining a page richness of the second type of page includes, but is not limited to:

1) extracting a page content block in a markup language file of the second type of page to which the search result directs, e.g., a body content block, calculating a text information length in the body content block, and determining a page richness of the second type of page according to the number of characters of the text information in the body content block and based on a first predetermined richness rule; for example, the more the number of characters of the text information in the body content block in the second type of page is, the higher is the page richness of the second type of page;

Herein, the page content block in the markup language file includes a content area identified by one or more tags in the markup language file, which content area corresponds to specific content displayed on the page, e.g., corresponding to headers, pictures, body contents, etc.

2) extracting page content blocks in the markup language file of the second type of page, and determining a page richness of the second type of page according to the number of types of the page content blocks, and based on a second predetermined richness rule; for example, the more the types of the page content blocks included in the second type of page is, e.g., body content block, header content block, picture content block, message content block, etc., the higher is its page richness.

In one example, the page content block identification information is stored in a tag attribute of a markup language file XMTML file of a WAP page to which the search result A1 directs, e.g., in the tag attribute of a paragraph tag <p>, the ranking module resolves the XHTML file to determine the paragraph tag attribute <p tc_type=“TEXT”> for marking up the body content block in the XHTML file; then, the XHTML file portion between the paragraph tag <p tv_type=“TEXT”> and </p> is extracted to obtain the body content block of the page, and then the number of characters of the text information in the body content block is calculated to obtain that the number of characters of the text information is 100 characters; the score of the page richness of the WAP page is added by 1 when the number of characters of text information in the body content block is greater than 100 characters based on the first predetermined richness rule; meanwhile, the network device determines, through resolving the XHTML file, that the WAP page to which A1 directs to comprises 4 kinds of page content blocks, which are body content block, header content block, catalog content block, and picture content block, and based on a second predetermined richness rule, when the second type of page includes more than 4 kinds of page content blocks, the score of the page richness of the second page is added by 1, i.e., the score rA1 of the page richness of the WAP page to which A1 directs is 2.

Specifically, the manner of determining relevancy information between the header information of a second type of page and the content information of a second type of page includes, but is not limited to:
determining relevancy information of the two through TF-IDF algorithm based on the header information of the second type of page and the content information of the second type of page; wherein, the TD-IDF is a statistical method, for evaluating the importance degree of one word with respect to one file in a file set or corpus.

In one example, the network device performs word segmentation processing to the header information “flower express” of the WAP page to which the search result A1 directs to obtain two phase segments: P1 “flower” and P2 “express”; next, query is performed in a preset corpus to determine that the appearance frequencies TPs of the two phase segments in the preset corpus are 100 times and 200 times, respectively, taking the reciprocals of the appearance frequencies as the inverse text frequency IDF of each phase segment which are 0.01 and 0.005, respectively; besides, it is determined that the appearance frequencies TFs of the two phase segments in the text information of the body content block of the WAP page are 10 times and 20 times, respectively; afterwards, calculation is performed through equation 1):

Pn=TFn*IDFn 1)

Wherein, Pn denotes a score of relevancy information between each phase segment and content information of the WAP page,

TFn denotes respective appearance frequency of each phase segment in the text information of the body content block of the WAP page,

IDFn denotes a reciprocal of appearance frequency of each word segment in a preset corpus;

to determine that the score of relevancy information between each word segment and the content information of the WAP page is:

P1: 0.01*10=0.1;

P2: 0.005*20=0.1;

performing summing calculation with respect to the scores of relevancy information between the two phase segments and the content information of the WAP page, to obtain that the score CA1 (=p1+p2) of the relevancy information between the header information of the WAP page to which the search result A1 directs and the content information of the WAP page is 0.2.

Preferably, the score rAn of the page richness of the second type of page to which each search result directs and the score CAn of the relevancy information between the header information of the second type of page and the content information of the second type of page are subject to simple summing or weighted calculation, etc., for example, through the following equation 2):

QAn=rAn+CAn

wherein QAn denotes a score of a page quality of the second type of page, rAn denotes a score of a page richness of the second type of page, CAn denotes a score of a page richness of the second type of page; to obtain a score QAn of the page quality of the second type of page to which each search result in at least one search result directs.

It should be noted that the above example is only for better illustrating the technical solution of the present invention, not intended to limit the present invention. Those skilled in the art should understand that any manner of determining rank adjustment information to which at least one search result corresponds respectively, based on the determined characteristic degree of the second type of page to which each search result in the determined at least one search result directs, should fall into the scope of the present invention.

Afterwards, in step S4, the network device performs a ranking processing to the plurality of search results based on the relevancy information between the query sequence and the plurality of search results and the rank adjustment information to which the at least one search result corresponds respectively, so as to obtain a plurality of ranked search results.

Herein, in step S4, the manner in which the network device 4 performs ranking processing to a plurality of search results to obtain a plurality of ranked search results includes, but is not limited to performing a summing calculation with respect to the scores of relevancy information between each search result and a query sequence, the score of page quality of the second type of page to which at least one search result having a page correspondence relationship directs respectively, and the score of page similarity information between the second type of page and the first type of page to which the at least one search result having a page correspondence relationship directs respectively, and performing a ranking operation based on the summing results.

In one example, a plurality of search results are A1, A2, A3, and A4; the scores of the relevancy information between the four search results which have been obtained and the query sequence are RA1: 10, RA2: 5, RA3: 4, and RA4: 3; in the four search results, A1 and A4 are search results having a page correspondence relationship, and the scores of the page qualities of the second type of pages to which A1 and A14 directs respectively and have been obtained are QA1: 1 and QA4: 4; the scores of the page similarity information between the second type of pages and the first type of pages to which A1 and A4 directs respectively and have been obtained are SA1: 0.5 and SA4: 0.9; in step S4, the network device performs summing calculation to the relevancy information, the score of the page quality of the second type of page, and the score of the page similarity information between the second type of page and the first type of page, of A1 and A14, namely, through equation 3):

sn=RAn+QAn+SAn 3)

wherein, sn denotes the summing result,

RAn denotes the score of relevancy information of each search result and the query sequence,

QAn denotes the score of the page quality of the second type of page to which each search result directs,

SAn denotes the score of the page similarity information between the second type of page and the first type of page to which each search result directs;

the obtained summing result is:

s1:=10+1+0.5=11.5;

s4:=3+4+0.9=7.9;

then the network device ranks the four search results based on the relevancy information of A2 and A3, as well as the summing result, obtaining the ranked four search results being A1, A4, A2, and A3.

It should be noted that the above example is only for better illustrating the technical solution of the present invention, rather than limiting the present invention. Those skilled in the art should understand, any implementation manner of performing a ranking processing to the plurality of search results based on the relevancy information between the query sequence and the plurality of search results and the rank adjustment information respectively corresponding to the at least one search result, so as to obtain a plurality of ranked search results, should fall into the scope of the present invention.

By performing a ranking processing to a plurality of search results based on the relevancy information between each search result and the query sequence and the rank adjustment information respectively corresponding to the at least one search result having a page correspondence relationship, a ranking manner for the plurality of search results is not only related to the match degree with the query sequence inputted by the user, but also associated with whether the search result page is suitable for being presented on the mobile terminal, such that the search results corresponding to the second type of page suitable for being presented on the mobile terminal and having a higher page quality and the search results which correspond to the first type of page and the second type of page, are suitable for being presented on the mobile terminal, and have relatively higher page similarity information, can be ranked at higher positions of the search result pages, and the user may click onto several search results ranked top in a visual area most convenient for him/her to obtain information, to obtain the search result webpages suitable for him/her to browse at the mobile terminal, thereby improving the user's browsing experience.

Preferably, the method further comprises step S41 (not shown) and step S42 (not shown). In step S41, the network device performs weighted calculation based on the relevancy information between the query sequence and the plurality of search results and the rank adjustment information respectively corresponding to the at least one search result and in conjunction with the predetermined weights of the relevancy information and the rank adjustment information, to determine a weighted ranking result for each search result; in step S42, the network device performs a ranking processing to the plurality of search results based on the weighted ranking result of the each search result to obtain a plurality of ranked search results.

In one example, a plurality of search results are A1, A2, A3, and A4; the scores of the relevancy information between the four search results obtained by the search-result-obtaining module 1 and the query sequence are RA1: 10, RA2: 5, RA3:4 , and RA4: 3; in the four search results, A1 and A4 are search results having a page correspondence relationship, and the scores of the page qualities of the second type of page to which A1 and A4 as obtained direct respectively are QA1: 1 and QA4: 4; the scores of the page similarity information between the second type of page to which A1 and A4 direct respectively and have been obtained are SA1: 0.5 and SA4: 0.9; additionally, the predetermined weight of the relevancy information is W1: 1; the predetermined weight of the page quality of the second type of page to which the search result directs is W2: 0.4; the predetermined weight of the page similarity information between the second type of page and the first type of page to which the search result directs is W3: 0.3; then, in step S41, the network device performs weighted calculation to the relevancy information, the score of the page quality of the second type of page, and the score of the page similarity information between the second type of page and the first type of page, of A1 and A4, namely, through equation 4):

Sn=RAn*W1+QAn*W2+SAn*W3 4)

to obtain the weighted results as:

S1:=10*1+1*0.4+0.5*0.3=10.55;

S4:=3*1+4*0.4+0.9*0.3=4.87;

Then, in step S42, the network device ranks the four search results based on the relevancy information of A2 and A3, as well as the weighted results, to obtain the four ranked search results to be A1, A2, A4 and A3.

It should be noted that the above example is only for better illustrating the technical solution of the present invention, rather than limiting the present invention. Those skilled in the art should understand, any implementation manner of performing weighted calculation based on the relevancy information between the query sequence and the plurality of search results and the rank adjustment information respectively corresponding to the at least one search result and in conjunction with predetermined weights of the relevancy information and the rank adjustment information, to determine a weighted ranking result for each search result, and then performing a ranking processing to the plurality of search results based on the weighted ranking result of the each search result to obtain a plurality of ranked search results, should fall into the scope of the present invention.

Since different ranking dimensions for ranking at least one search result having a page correspondence relationship have different impacts on the suitability of presenting the search results on the mobile terminal; therefore, by assigning different weights based on the importance of respective ranking dimensions, the search result page corresponding to the finally obtained plurality of ranked search results not only has a higher match degree with the query sequence, but also is suitable to be presented on a mobile terminal, such that the user can obtain a plurality of ranked search results simultaneously satisfying his/her query needs and the browsing experience.

As one of the preferred solutions of the present embodiment, FIG. 4 shows a flow diagram of a method for determining page similarity information between a first type of page and a second type of page, which are directed to by the each search result according to one preferred embodiment of the present invention, wherein the method according to the present preferred embodiment comprises step S1, step S2, step S3, step S4, step S5, and step S6.

Herein, step S1, step S2, step S3, and step S4 have been described in detail in the embodiment shown in FIG. 3, which will not be detailed here.

In step S5, the network device extracts main page content blocks of the first type of page and the second type of page to which each search result in the at least one search result directs.

The manner of storing the page content block identification information in the first type of page and the second type of page to which each search result in the at least one search result directs includes, but is not limited to, at least any one of the following manners:

1) stored in the annotation of a markup language file;

For example, with a JSON format, the page content block identification information is stored in the annotation of an XHTML file, e.g., <!--tc block_begin: {type: “TITLE”}--><!--tc block_end-->; by resolving the XHTML file, instep S5, the network device determines an annotation for marking up the header content block from within the XHTML file, to extract the HTML file portion between the annotations <!--tc block_begin: {type: “TITLE”}--> and <!--tc block_end-->, thereby extracting the header content block of the page; wherein the JSON format is a light-weight data exchange format, which generally adopts a “name/value” pair approach to represent data, and the name and the value is separated with “:”.

2) stored in a customized tag of the markup language file;

For example, the page content block identification information is stored in a customized tag <tc></tc> of the XHTML file; by resolving the XHTML file, in step 5, the network device determines, in the XHTML file, the customized tag <tc type=“photo”> for marking up a picture content block, to extract the HTML file portion between <tc type=“photo”> and </tc>, thereby obtaining the picture content block of the page.

3) stored in a tag attribute of the markup language file;

For example, the page content block identification information is stored in the tag attribute of the XHTML file, e.g., in the tag attribute of the paragraph tag <p>; by resolving the XHTML file, in step S5, the network device determines, in the XHTML file, the paragraph tag attribute <p tc_type=“TEXT”> for annotating a body content block, and then extracts the XHTML file portion between the paragraph tag <p tc_type=“TEXT”> and </p>, to obtain the body content block of the page.

In one example, the search result having a page correspondence relationship is A5; in step S5, the network device extracts within a markup language file of the first type of page and the second type of page to which each search result directs, to extract and obtain the header content block and the body content block included in the first type of page and the second type of page of A5, respectively, as the main page content blocks of the two pages.

Afterwards, in step S6, the network device performs text similarity calculation with respect to the main page content blocks of the first type of page and the second type of page of each search result, to determine the page similarity information between the first type of page and the second type of page to which each search result directs.

Herein, the manner of determining page similarity between the first type of page and the second type of page to which each search result is directed includes, but is not limited to:

1) calculating with the TF-IDF algorithm to determine; e.g., extracting a plurality of key words in the main page content block of the first type of page, and then determining appearance frequencies of the plurality of key words in the main content block of the second type of page, respectively, and determine, with the TF-IDF algorithm, the page similarity between the first type of page and the second type of page;

2) spatial vector-based cosine algorithm; wherein the processing process of the algorithm comprises pre-processing such as word segmenting the text information, and then filtering off common adverbs, auxiliary verbs which have a high frequency in the text information, determining a plurality of keywords based on the frequencies of remaining phase segments, performing weighted calculation through the TF-IDF formulation, thereby generating a spatial vector model, and finally calculating cosine, to determine the similarity between the text information in the main page content blocks in the first type of page and the second type of page.

It should be noted that the above example is only for better illustrating the technical solution of the present invention, rather than limiting the present invention. Those skilled in the art should understand, any implementation manner of extracting main page content blocks of the first type of page and the second type of page to which each search result in the at least one search result is directed and then performing text similarity calculation with respect to the main page content blocks of the first type of page and the second type of page of each search result, to determine page similarity information between the first type of page and the second type of page to which each search result directs, should fall into the scope of the present invention.

It should be noted that the present invention may be implemented in software and/or a combination of software and hardware. For example, each module of the present invention may be implemented by an application-specific integrated circuit (ASIC) or any other similar hardware device. In one embodiment, the software program of the present invention may be executed through a processor to implement the steps or functions as mentioned above. Likewise, the software program (including relevant data structure) of the present invention may be stored in a computer readable recording medium, e.g., RAM memory, magnetic or optic driver or soft floppy or similar devices. Additionally, some steps or functions of the present invention may be implemented by hardware, for example, a circuit cooperating with the processor so as to implement various steps of functions.

The present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations falling into the meaning and scope of equivalent elements of the claims are intended to be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, and not to indicate any particular sequence.

1-17. (canceled)

18. A method comprising ranking search results, wherein ranking search results comprises performing a match query based on a query sequence from a mobile terminal to obtain a plurality of search results matching the query sequence, and relevancy information between the query sequence and the plurality of search results, wherein each search result in the plurality of search results directs to a first type of page and a second type of page having a page correspondence relationship, wherein the second type of page is a page suitable for being displayed on the mobile terminal, determining a search result in the plurality of search results, determining rank adjustment information to which the search result corresponds respectively based on a characteristic degree of the second type of page directed to by each search result, and performing a ranking process on the plurality of search results based on the relevancy information between the query sequence and the plurality of search results and the rank adjustment information to which the search result corresponds respectively, thereby obtaining a plurality of ranked search results.

19. The method of claim 18, wherein determining a search result in the plurality of search results comprises determining, through extracting a predetermined tag in a markup language file of the first type of page to which the plurality of search results correspond respectively, the search result in the plurality of search results.

20. The method of claim 18, wherein performing a ranking process on the plurality of search results comprises performing weighted calculation based on the relevancy information between the query sequence and the plurality of search results and the rank adjustment information to which the search result corresponds respectively, and in conjunction with predetermined weights of the relevancy information and the rank adjustment information, to determine a weighted ranking result for each search result, and performing a ranking process on the plurality of search results based on the weighted ranking result of each search result to obtain a plurality of ranked search results.

21. The method of claim 19, wherein performing a ranking process on the plurality of search results comprises performing weighted calculation based on the relevancy information between the query sequence and the plurality of search results and the rank adjustment information to which the search result corresponds respectively, and in conjunction with predetermined weights of the relevancy information and the rank adjustment information, thereby determining a weighted ranking result for each search result, and performing a ranking process on the plurality of search results based on the weighted ranking result of each search result to obtain a plurality of ranked search results.

22. The method claim 18, wherein the characteristic degree of the second type of page is selected from the group consisting of page quality of the second type of page to which each search result directs, and page similarity information between the second type of page and the first type of page that are directed to by each search result.

23. The method of claim 22, further comprising determining the page quality of the second type of page to which the search result directs based on at least one of page richness of the second type of page, and relevancy information between the header information of the second type of page and the content information of the second type of information.

24. The method of claim 22, further comprising extracting main page content blocks of the first type of page and the second type of page to which each search result in the plurality of search results directs, and performing a text similarity calculation with respect to the main page content blocks of the first type of page and the second type of page of each search result to determine the page similarity information between the first type of page and the second type of page to which each search result directs.

25. The method claim 23 further comprising extracting main page content blocks of the first type of page and the second type of page to which each search result in directs, and performing text similarity calculation with respect to the main page content blocks of the first type of page and the second type of page of each search result to determine the page similarity information between the first type of page and the second type of page to which each search result directs.

26. An apparatus comprising a ranking apparatus for ranking search results, said ranking apparatus comprising a search-result-obtaining module configured to perform a match query, based on a query sequence from a mobile terminal, to obtain a plurality of search results matching the query sequence and relevancy information indicative of relevance between the query sequence and the plurality of search results, a search-result-determining module configured to determine at least one search result in the plurality of search results, wherein the result directs to a first type of page and a second type of page having a page correspondence relationship, wherein the second type of page is a page suitable for being displayed on the mobile terminal, an adjustment-information-determining module configured to determine rank adjustment information to which the search result corresponds based on a characteristic degree of the second type of page directed to by the at least one search result, and a first ranking-module configured to perform a ranking process on the plurality of search results based on the relevancy information between the query sequence and the plurality of search results and the rank adjustment information to which the search result corresponds respectively, so as to obtain a plurality of ranked search results.

27. The apparatus of claim 26, wherein the search-result-determining module comprises a tag-extracting module configured to determine, through extracting a predetermined tag in a markup language file of the first type of page to which the plurality of search results correspond respectively, the search result in the plurality of search results.

28. The apparatus of claim 26, wherein the first ranking-module comprises a weighting module configured to perform weighted calculation based on the relevancy information between the query sequence and the plurality of search results and the rank adjustment information to which the search result corresponds respectively, and in conjunction with predetermined weights of the relevancy information and the rank adjustment information, to determine a weighted ranking result for each search result, and a second ranking module configured to perform a ranking process on the plurality of search results based on the weighted ranking result of each search result to obtain a plurality of ranked search results.

29. The apparatus of claim 27, wherein the first ranking module comprises a weighting module configured to perform weighted calculation based on the relevancy information between the query sequence and the plurality of search results and the rank adjustment information to which the search result corresponds respectively, and in conjunction with predetermined weights of the relevancy information and the rank adjustment information, to determine a weighted ranking result for each search result, and a second ranking module configured to perform a ranking process on the plurality of search results based on the weighted ranking result of the each search result to obtain a plurality of ranked search results.

30. The apparatus of claim 26, wherein the characteristic degree of the second type of page is selected from the group consisting of page quality of the second type of page to which each search result directs, and page similarity information between the second type of page and the first type of page that are directed to by each search result.

31. The apparatus of claim 30, wherein the page quality of the second type of page to which the search result directs respectively is based on at least one of page richness of the second type of page, and relevancy information between the header information of the second type of page and the content information of the second type of information.

32. The apparatus of claim 30, further comprising an extracting module configured to extract main page content blocks of the first type of page and the second type of page to which the search result directs, and a similarity-determining module configured to perform text-similarity calculation with respect to the main page content blocks of the first type of page and the second type of page of each search result to determine the page similarity information between the first type of page and the second type of page to which each search result directs.

33. The apparatus of any one of claim 31, wherein the ranking apparatus further comprises an extracting module configured to extract main page content blocks of the first type of page and the second type of page to which each search result directs, and a similarity-determining module configured to perform text-similarity calculation with respect to the main page content blocks of the first type of page and the second type of page of each search result, to determine the page similarity information between the first type of page and the second type of page to which each search result directs.

34. A manufacture comprising a non-transitory computer-readable medium having encoded thereon computer code that, when executed, causes a computer system to implement the method of claim 18.
